(19) United States
(12) Patent Application Publication
(10) Pub. No.: US 2026/0222537 A1
(43) Pub. Date: Jul. 30, 2026

(54) Method and Apparatus of Cross-Component Discrete Model in Video Coding System

(71) Applicant: MEDIATEK INC., Hsinchu City (TW)

(72) Inventors: Hsin-Yi TSENG, Hsinchu City (TW); Chia-Ming TSAI, Hsinchu City (TW); Cheng-Yen CHUANG, Hsinchu City (TW); Tzu-Der CHUANG, Hsinchu City (TW); Chih-Wei HSU, Hsinchu City (TW)

(21) Appl. No.: 19/147,391

(22) PCT Filed: Jan. 18, 2024
(86) PCT No.: PCT/CN2024/073108

§ 371 Date: Jul. 11, 2025

Related U.S. Application Data
(60) Provisional application No. 63/480,329, filed on Jan. 18, 2023.

(51) Int. Cl. H04N 19/105; H04N 19/176; H04N 19/186

(52) U.S. Cl. CPC H04N 19/105; H04N 19/176; H04N 19/186

(57) ABSTRACT

A method and apparatus of cross-component coding using one or more cross-component palette tables. According to this method, one or more cross-component palette tables are determined, wherein each of said one or more cross-component palette tables comprising one or more entries and each entry maps one first-colour sample value to one or more second-colour sample values. Said one or more second-colour current blocks are encoded or decoded using coding information comprising a cross-component palette-based model and the cross-component palette-based model corresponds to said one or more cross-component palette tables.

### CROSS REFERENCE TO RELATED APPLICATIONS

The present invention is a non-Provisional application of and claims priority to U.S. Provisional Patent Application No. 63/480,329, filed on Jan. 18, 2023. The U.S. Provisional patent application is hereby incorporated by reference in its entirety.

### FIELD OF THE INVENTION

The present invention relates to video coding using cross-component models. In particular, the present invention relates to a new coding tool that generates cross-colour prediction using one or more cross-component palette tables.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously coded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

The VVC standard incorporates various new coding tools to further improve the coding efficiency over the HEVC standard. In the present invention, new cross-component coding tool using one or more cross-component palette tables is disclosed.

### BRIEF SUMMARY OF THE INVENTION

A method and apparatus of cross-component coding using one or more cross-component palette tables are disclosed. According to this method, input data associated with a current block comprising a first-colour current block associated with a first-colour component and one or more second-colour current blocks associated with one or more second-colour components respectively are received, wherein the input data comprise pixel data to be encoded at an encoder side or data associated with the current block to be decoded at a decoder side. One or more cross-component palette tables are determined, wherein each of said one or more cross-component palette tables comprising one or more entries and each entry maps one first-colour sample value to one or more second-colour sample values. Said one or more second-colour current blocks are encoded or decoded using coding information comprising a cross-component palette-based model and the cross-component palette-based model corresponds to said one or more cross-component palette tables.

In one embodiment, the first-colour current block corresponds to a luma block and said one or more second-colour current blocks corresponds to a first chroma block and a second chroma block. In one embodiment, said one or more cross-component palette tables corresponds to a first cross-component palette table and a second cross-component palette table, and wherein each entry of the first cross-component palette table maps one luma sample value to one first chroma sample value and each entry of the second cross-component palette table maps one luma sample value to one second chroma sample value. In another embodiment, said one or more cross-component palette tables correspond to a joint cross-component palette table, and wherein each entry of the joint cross-component palette table maps one luma sample value to one first chroma sample value and one second chroma sample value.

In one embodiment, a second-colour sample in the current block is predicted by using said one or more cross-component palette tables, and wherein a first-colour sample value for a collocated first-colour sample corresponding to the second-colour sample is looked up in said one or more cross-component palette tables to determine a corresponding second-colour value as a predicted second-colour value for the second-colour sample.

In one embodiment, said one or more cross-component palette tables are built based on reconstructed or prediction samples, at collocated location, of the first-colour component and said one or more second-colour components in one or more previously coded blocks.

In one embodiment, one cross-component palette-based model is maintained across multiple CUs (Coding Units) and said one cross-component palette-based model is reset at beginning or end of a current picture, slice, tile, CTU (Coding Tree Unit) group, M CTU rows or N CTUs.

In one embodiment, each picture is divided into N regions and N cross-component palette-based models are maintained, and wherein each cross-component palette-based model is derived based on reconstructed or prediction samples of the first-colour component and said one or more second-colour components in each region and N is a positive integer greater than 1. In one embodiment, one extra cross-component palette-based model is updated during encoding or decoding process. In one embodiment, two or more of the N cross-component palette-based models are merged to form a merged cross-component palette-based model, and the merged cross-component palette-based model is used for encoding or decoding said one or more second-colour current blocks. In one embodiment, said two or more of the N cross-component palette-based models are determined according to location of the current block. In one embodiment, if a target first-colour sample value exists in more than one cross-component palette table associated with said two or more of the N cross-component palette-based models, a corresponding target second-colour sample value for the merged cross-component palette-based model is derived based on an average value, a majority value or a highest priority value of corresponding second-colour sample values in said more than one cross-component palette table.

In one embodiment, one cross-component palette-based model is updated based on reconstructed or prediction samples of the first-colour component and said one or more second-colour components in a target block after the target block is coded. In one embodiment, if a target first-colour sample value is not in said one or more cross-component palette tables corresponding to said one cross-component palette-based model, mapping from the target first-colour sample value to one or more target second-colour sample values at the collocated location is added to said one or more cross-component palette tables. In one embodiment, if a target first-colour sample value is in said one or more cross-component palette tables corresponding to said one cross-component palette-based model, mapping from the target first-colour sample value to one or more target second-colour sample values at the collocated location is used to replace a corresponding entry in said one or more cross-component palette tables. In one embodiment, if a target first-colour sample value has multiple corresponding second-colour sample values in the target block, a target second-colour sample value is used for said one or more cross-component palette tables, and wherein the target second-colour sample value corresponds to an average, a majority value, or a closest value to a centre intensity value of multiple corresponding second-colour sample values. In one embodiment, said one cross-component palette-based model is only updated for the target block coded in one or more certain types. In one embodiment, said one or more certain types correspond to a cross-component prediction mode or a cross-component palette-based model based on said one or more cross-component palette tables.

In one embodiment, if a cross-component prediction mode is enabled for the current block, said one or more second-colour current blocks are adaptively encoded or decoded using the cross-component prediction mode or said one or more cross-component palette tables. In one embodiment, said one or more second-colour current blocks are adaptively encoded or decoded using the cross-component prediction mode or said one or more cross-component palette tables depending on construction samples used for deriving a cross-component prediction model associated with the cross-component prediction mode. In one embodiment, for a target first-colour sample in the current block, if a value of a first-colour reconstruction sample occurs only once in said deriving the cross-component prediction model, a corresponding target second-colour value from the corresponding said one or more cross-component palette tables is used to encode or decode a corresponding second-colour sample in the current block. In another embodiment, if a value of a first-colour reconstruction sample occurs multiple time in said deriving the cross-component prediction model, the cross-component prediction model is used to encode or decode a corresponding second-colour sample in the current block.

In one embodiment, if a cross-component prediction mode is enabled for the current block, said one or more second-colour current blocks are always encoded or decoded using said one or more cross-component palette tables.

In one embodiment, said one or more cross-component palette tables are shared with a palette table used for a palette prediction mode. In one embodiment, said one or more cross-component palette tables are used to update the palette table, or the palette table is used to update said one or more cross-component palette tables. In one embodiment, when a target sample in the current block is encoded or decoded by an escape code in the palette prediction mode, or when signalling a new palette entry, said one or more cross-component palette tables are used for signalling or parsing the target sample value. In one embodiment, the first-colour component corresponds to luma component and said one or more second-colour components correspond to two chroma components, and only the luma component of the target sample is signalled. In this case, the two chroma components of the target sample can be derived according to said one or more cross-component palette tables.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 shows an example of the location of the left and above samples and the sample of the current block involved in the LM_LA mode.

FIG. 3 shows an example of classifying the neighbouring samples into two groups according to multiple mode CCLM.

FIG. 4A illustrates an example of the CCLM model.

FIG. 4B illustrates an example of the effect of the slope adjustment parameter “u” for model update.

FIG. 5 illustrates an example of spatial part of the convolutional filter.

FIG. 6 illustrates an example of reference area with paddings used to derive the filter coefficients.

FIG. 7 illustrates the 16 gradient patterns for Gradient Linear Model (GLM).

FIG. 8 illustrates an example of a block coded in the palette mode.

FIGS. 9A-B illustrate examples of subblock-based index map scanning for palette: horizontal scanning (FIG. 9A) and vertical scanning (FIG. 9B).

FIG. 10A illustrates an example of two separate palette tables for cross-component palette-based mode.

FIG. 10B illustrates an example of one joint palette tables for cross-component palette-based mode.

FIG. 11 illustrates an example of multiple regions for building cross-component palette-based models, where each grid represents a CTU.

FIG. 12 illustrates a flowchart of an exemplary video coding system that incorporates cross-component palette-based models according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

Some new tools relevant to the present invention are reviewed as follows.

### Cross-Component Linear Model (CCLM) Prediction

To reduce the cross-component redundancy, a cross-component linear model (CCLM) (sometimes abbreviated as LM mode) prediction mode is used in the VVC, for which the chroma samples are predicted based on the reconstructed luma samples of the same CU by using a linear model as follows:

$${pred}_{C} ( i , j ) = α \cdot {rec}_{L}^{′} ( i , j ) + β \qquad ( 1 )$$

where pred_{C}(i, j) represents the predicted chroma samples in a CU and rec_{L}′ (i, j) represents the down-sampled reconstructed luma samples of the same CU.

The CCLM parameters (α and β) are derived with at most four neighbouring chroma samples and their corresponding down-sampled luma samples. Suppose the current chroma block dimensions are W×H, then W′ and H′ are set as
W′=W, H′=H when LM_LA mode is applied;
W′=W+H when LM_A mode is applied;
H′=H+W when LM_L mode is applied.

The above neighbouring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when LM_LA mode is applied and both above and left neighbouring samples are available;
S[W′/8, −1], S[3*W′/8, −1], S[5*W′/8, −1], S[7*W′/8, −1] when LM_A mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available.

The four neighbouring luma samples at the selected positions are down-sampled and compared four times to find two larger values: X⁰_{A} and X¹_{A}, and two smaller values: X⁰_{B} and X¹_{B}. Their corresponding chroma sample values are denoted as y⁰_{A}, y¹_{A}, y⁰_{B} and y¹_{B}. Then x_{A}, x_{B}, y_{A} and y_{B} are derived as:

Xa=(x0A+x1A+1)>>1;

$$\begin{matrix}Xb = ( x 0 B + x 1 B + 1 ) ≫ 1 ; \\ Ya = ( y 0 A + y 1 A + 1 ) ≫ 1 ; \\ Yb = ( y 0 B + y 1 B + 1 ) ≫ 1\end{matrix} \qquad ( 2 )$$

Finally, the linear model parameters α and β are obtained according to the following equations.

$$α = \frac{{Y}_{a} - {Y}_{b}}{{X}_{a} - {X}_{b}} \qquad ( 3 )$$

$$β = {Y}_{b} - α \cdot {X}_{b} \qquad ( 4 )$$

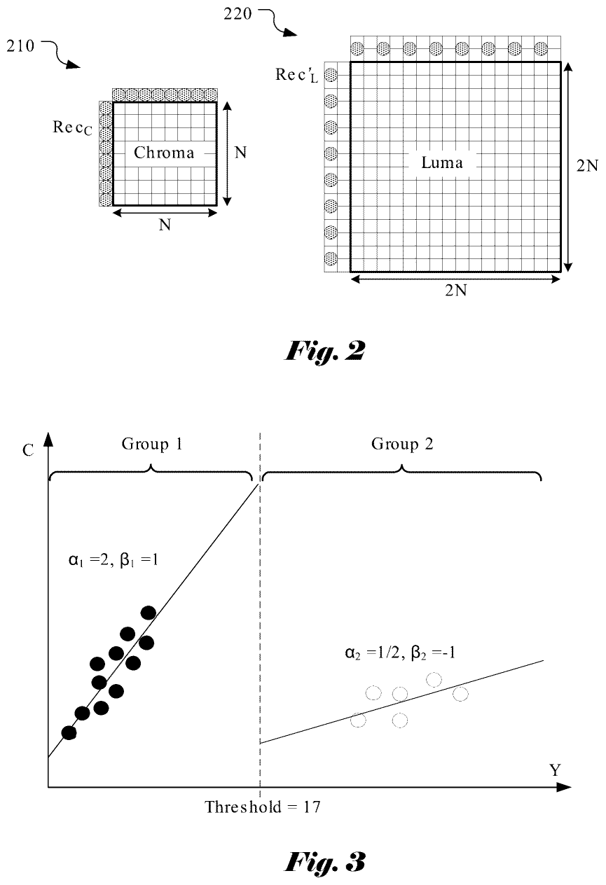

FIG. 2 shows an example of the location of the left and above samples and the sample of the current block involved in the LM_LA mode. FIG. 2 shows the relative sample locations of N×N chroma block 210, the corresponding 2N×2N luma block 220 and their neighbouring samples (shown as filled circles).

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

$$DivTable [ ] = \{ 0 , 7 , 6 , 5 , 5 , 4 , 4 , 3 , 3 , 2 , 2 , 1 , 1 , 1 , 1 , 0 \} \qquad ( 5 )$$

This would have a benefit of both reducing the complexity of the calculation as well as the memory size required for storing the needed tables.

Besides the above template and left template can be used to calculate the linear model coefficients together, they also can be used alternatively in the other 2 LM modes, called LM_A, and LM_L modes.

In LM_A mode, only the above template is used to calculate the linear model coefficients. To get more samples, the above template is extended to (W+H) samples. In LM_L mode, only the left template is used to calculate the linear model coefficients. To get more samples, the left template is extended to (H+W) samples.

In LM_LA mode, left and above templates are used to calculate the linear model coefficients.

To match the chroma sample locations for 4:2:0 video sequences, two types of down-sampling filters are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$${Rec}_{L}^{′} ( i , j ) = [ {rec}_{L} ( 2 i - 1 , 2 j - 1 ) + 2 \cdot {rec}_{L} ( 2 i , 2 j - 1 ) + {rec}_{L} ( 2 i + 1 , 2 j - 1 ) + {rec}_{L} ( 2 i - 1 , 2 j ) + 2 \cdot {rec}_{L} ( 2 i , 2 j ) + {rec}_{L} ( 2 i + 1 , 2 j ) + 4 ] ≫ 3 \qquad ( 6 )$$

$${Rec}_{L}^{′} ( i , j ) = {rec}_{L} ( 2 i , 2 j - 1 ) + 2 \cdot {rec}_{L} ( 2 i - 1 , 2 j ) + 4 \cdot {rec}_{L} ( 2 i , 2 j ) + {rec}_{L} ( 2 i - 1 , 2 j ) + 2 \cdot {rec}_{L} ( 2 i , 2 j + 1 ) + 4 ] ≫ 3 \qquad ( 7 )$$

Note that only one luma line (general line buffer in intra prediction) is used to derive the down-sampled luma samples when the upper reference line is at the CTU boundary. An exception happens if the top line of the current block is a CTU boundary. In this case, the one-dimensional filter [1, 2, 1]/4 is applied to the above neighbouring luma samples in order to avoid the usage of more than one luma line above the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five traditional intra modes and three cross-component linear model modes (i.e., {LM_LA, LM_L, and LM_A}, or {CCLM_LT, CCLM_L, and CCLM_T}). The terms of {LM_LA, LM_L, LM_A} and {CCLM_LT, CCLM_L, CCLM_T} are used interchangeably in this disclosure. Chroma mode signalling and derivation process are shown in Table 1. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the centre position of the current chroma block is directly inherited.

TABLE 1
Derivation of chroma prediction mode from luma mode
when sps_cclm_enabled_flag is true

| Chroma | Corresponding luma intra prediction mode | | | | |
|---|---|---|---|---|---|
| prediction mode | 0 | 50 | 18 | 1 | X (0 <= X <= 66) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_fag as shown in Table 2.

TABLE 2
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2, the first bin indicates whether it is regular (0) or LM modes (1). If it is LM mode, then the next bin indicates whether it is LM_LA (0) or not. If it is not LM_LA, next 1 bin indicates whether it is LM_L (0) or LM_A (1). For this case, when sps_cclm_enabled_fag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2 are context coded with its own context model, and the rest bins are bypass coded.

In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node are allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### Multiple Model CCLM (MMLM)

In the JEM (J. Chen, E. Alshina, G. J. Sullivan, J.-R. Ohm, and J. Boyce, Algorithm Description of Joint Exploration Test Model 7, document JVET-G1001, ITU-T/ISO/IEC Joint Video Exploration Team (JVET), July 2017), multiple model CCLM mode (MMLM) is proposed for using two models for predicting the chroma samples from the luma samples for the whole CU. In MMLM, neighbouring luma samples and neighbouring chroma samples of the current block are classified into two groups, each group is used as a training set to derive a linear model (i.e., a particular α and β are derived for a particular group). Furthermore, the samples of the current luma block are also classified based on the same rule for the classification of neighbouring luma samples. Three MMLM model modes (MMLM_LT, MMLM_T, and MMLM_L) are allowed for choosing the neighbouring samples from left-side and above-side, above-side only, and left-side only, respectively.

FIG. 3 shows an example of classifying the neighbouring samples into two groups. Threshold is calculated as the average value of the neighbouring reconstructed luma samples. A neighbouring sample with Rec′_{L}[x,y]<=Threshold is classified into group 1; while a neighbouring sample with Rec′_{L}[x,y]>Threshold is classified into group 2.

$$\{ \begin{matrix}{Pred}_{C} [ x , y ] = {α}_{1} \times {Rec}_{L}^{′} [ x , y ] + {β}_{1} if {Rec}_{L}^{′} [ x , y ] \leq Threshold \\ {Pred}_{C} [ x , y ] = {α}_{2} \times {Rec}_{L}^{′} [ x , y ] + {β}_{2} if {Rec}_{L}^{′} [ x , y ] > Threshold\end{matrix} \qquad ( 8 )$$

Accordingly, the MMLM uses two models according to the sample level of the neighbouring samples.

### Slope Adjustment of CCLM

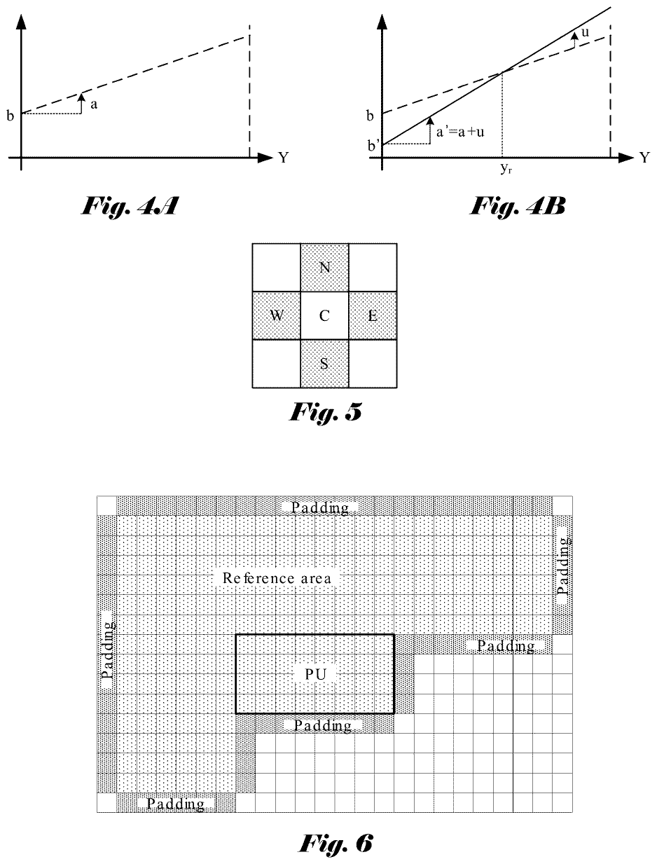

CCLM uses a model with 2 parameters to map luma values to chroma values as shown in FIG. 4A. The slope parameter “a” and the bias parameter “b” define the mapping as follows:

$$chromaVal = a * lumaVal + b$$

An adjustment “u” to the slope parameter is signalled to update the model to the following form, as shown in FIG. 4B:

$$chromaVal = {a}^{′} * lumaVal + {b}^{′}$$

$$where$$

$$\begin{matrix}{a}^{′} = a + u , \\ {b}^{′} = b - u * {y}_{r} .\end{matrix}$$

With this selection, the mapping function is tilted or rotated around the point with luminance value yᵣ. The average of the reference luma samples used in the model creation as yᵣ in order to provide a meaningful modification to the model. FIGS. 4A and 4B illustrate the process.

### Implementation of Slope Adjustment of CCLM

Slope adjustment parameter is provided as an integer between −4 and 4, inclusive, and signalled in the bitstream. The unit of the slope adjustment parameter is (⅛)-th of a chroma sample value per luma sample value (for 10-bit content).

Adjustment is available for the CCLM models that are using reference samples both above and left of the block (e.g. “LM_CHROMA_IDX” and “MMLM_CHROMA_IDX”), but not for the “single side” modes. This selection is based on coding efficiency versus complexity trade-off considerations. “LM_CHROMA_IDX” and “MMLM_CHROMA_IDX” refers to CCLM_LT and MMLM_LT in this invention. The “single side” modes refer to CCLM_L, CCLM_T, MMLM_L, and MMLM_T in this invention.

When slope adjustment is applied for a multi-model CCLM mode, both models can be adjusted and thus up to two slope updates are signalled for a single chroma block.

### Encoder Approach for Slope Adjustment of CCLM

The proposed encoder approach performs an SATD (Sum of Absolute Transformed Differences) based search for the best value of the slope update for Cr and a similar SATD based search for Cb. If either one results as a non-zero slope adjustment parameter, the combined slope adjustment pair (SATD based update for Cr, SATD based update for Cb) is included in the list of RD (Rate-Distortion) checks for the TU.

### Convolutional Cross-Component Model (CCCM)—Single Model and Multi-Model

In CCCM, a convolutional model is applied to improve the chroma prediction performance. The convolutional model has 7-tap filter consisting of a 5-tap plus sign shape spatial component, a nonlinear term and a bias term. The input to the spatial 5-tap component of the filter consists of a centre (C) luma sample which is collocated with the chroma sample to be predicted and its above/north (N), below/south (S), left/west (W) and right/east (E) neighbours as shown in FIG. 5.

The nonlinear term (denoted as P) is represented as power of two of the centre luma sample C and scaled to the sample value range of the content:

$$P = ( C * C + midVal ) ≫ bitDepth .$$

For example, for 10-bit contents, the nonlinear term is calculated as:

$$P = ( C * C + 512 ) ≫ 10$$

The bias term (denoted as B) represents a scalar offset between the input and output (similarly to the offset term in CCLM) and is set to the middle chroma value (512 for 10-bit content).

Output of the filter is calculated as a convolution between the filter coefficients ci and the input values and clipped to the range of valid chroma samples:

$$predChromaVal = {c}_{0} C + {c}_{1} N + {c}_{2} S + {c}_{3} E + {c}_{4} W + {c}_{5} P + {c}_{6} B$$

The filter coefficients ci are calculated by minimising MSE between predicted and reconstructed chroma samples in the reference area. FIG. 6 illustrates an example of the reference area which consists of 6 lines of chroma samples above and left of the PU. Reference area extends one PU width to the right and one PU height below the PU boundaries. Area is adjusted to include only available samples. The extensions to the area (indicated as “paddings”) are needed to support the “side samples” of the plus-shaped spatial filter in FIG. 5 and are padded when in unavailable areas.

The MSE minimization is performed by calculating autocorrelation matrix for the luma input and a cross-correlation vector between the luma input and chroma output. Autocorrelation matrix is LDL decomposed and the final filter coefficients are calculated using back-substitution. The process follows roughly the calculation of the ALF filter coefficients in ECM (Enhanced Compression Model), however LDL decomposition was chosen instead of Cholesky decomposition to avoid using square root operations.

### Gradient Linear Model (GLM)

Compared with the CCLM, instead of down-sampled luma values, the GLM utilizes luma sample gradients to derive the linear model. Specifically, when the GLM is applied, the input to the CCLM process, i.e., the down-sampled luma samples L, are replaced by luma sample gradients G. The other parts of the CCLM (e.g., parameter derivation, prediction sample linear transform) are kept unchanged.

$$C = α \cdot G + β$$

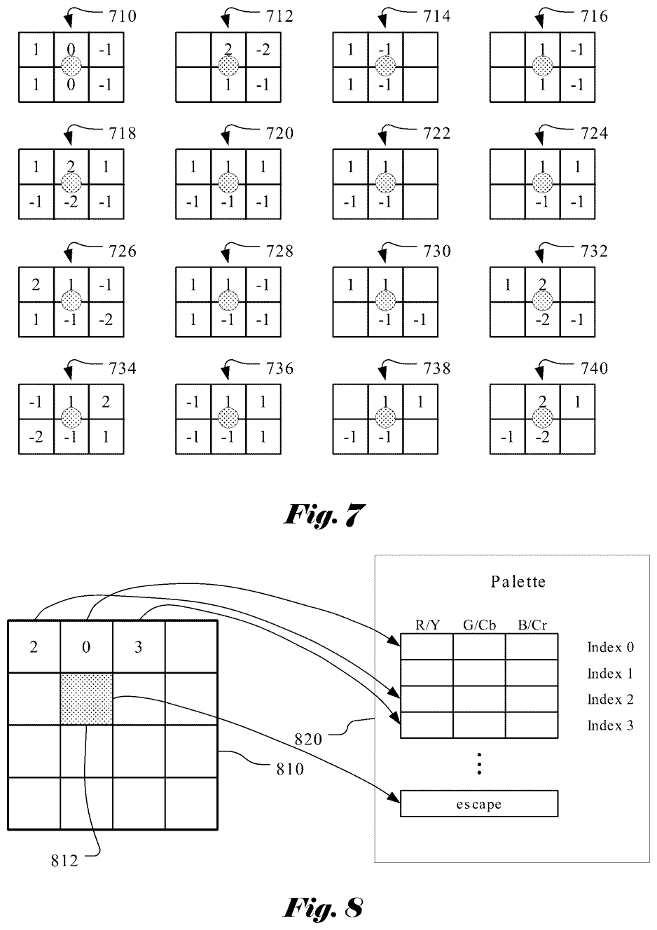

For signalling, when the CCLM mode is enabled for the current CU, two flags are signalled separately for Cb and Cr components to indicate whether GLM is enabled for each component. If the GLM is enabled for one component, one syntax element is further signalled to select one of 16 gradient filters (710-740 in FIG. 7) for the gradient calculation. The GLM can be combined with the existing CCLM by signalling one extra flag in bitstream. When such combination is applied, the filter coefficients that are used to derive the input luma samples of the linear model are calculated as the combination of the selected gradient filter of the GLM and the down-sampling filter of the CCLM.

### Palette Mode

In VVC, the palette mode is used for screen content coding in all of the chroma formats supported in a 4:4:4 profile (that is, 4:4:4, 4:2:0, 4:2:2 and monochrome). When the palette mode is enabled, a flag is transmitted at the CU level if the CU size is smaller than or equal to 64×64, and the number of samples in the CU is greater than 16 to indicate whether palette mode is used. Considering that applying palette mode on small CUs introduces insignificant coding gain and causes extra complexity on the small blocks, palette mode is disabled for CUs that are smaller than or equal to 16 samples. A palette coded Coding Unit (CU) is treated as a prediction mode other than intra prediction, inter prediction, and intra block copy (IBC) mode.

If the palette mode is utilized, the sample values in the CU are represented by a set of representative colour values. The set is referred to as the palette. For positions with sample values close to the palette colours, the palette indices are signalled. It is also possible to specify a sample that is outside the palette by signalling an escape symbol. For samples within the CU that are coded using the escape symbol, their component values are signalled directly using (possibly) quantized component values. This is illustrated in FIG. 8, where box 810 represent a palette coded block and the palette table 820 is shown on the right. The pixel 812 shown in a dot-filled square corresponds to a pixel coded in an escape code. The quantized escape symbol is binarized with fifth order Exp-Golomb binarization process (EG5).

For coding of the palette, a palette predictor is maintained. The palette predictor is initialized to 0 at the beginning of each slice for non-wavefront case. For WPP (Wavefront Parallel Processing) case, the palette predictor at the beginning of each CTU row is initialized to the predictor derived from the first CTU in the previous CTU row so that the initialization scheme between palette predictors and CABAC synchronization is unified. For each entry in the palette predictor, a reuse flag is signalled to indicate whether it is part of the current palette in the CU. The reuse flags are sent using run-length coding of zeros. After this, the number of new palette entries and the component values for the new palette entries are signalled. After encoding the palette coded CU, the palette predictor will be updated using the current palette, and entries from the previous palette predictor that are not reused in the current palette will be added at the end of the new palette predictor until the maximum size allowed is reached. An escape flag is signalled for each CU to indicate if escape symbols are present in the current CU. If escape symbols are present, the palette table is augmented by one and the last index is assigned to be the escape symbol.

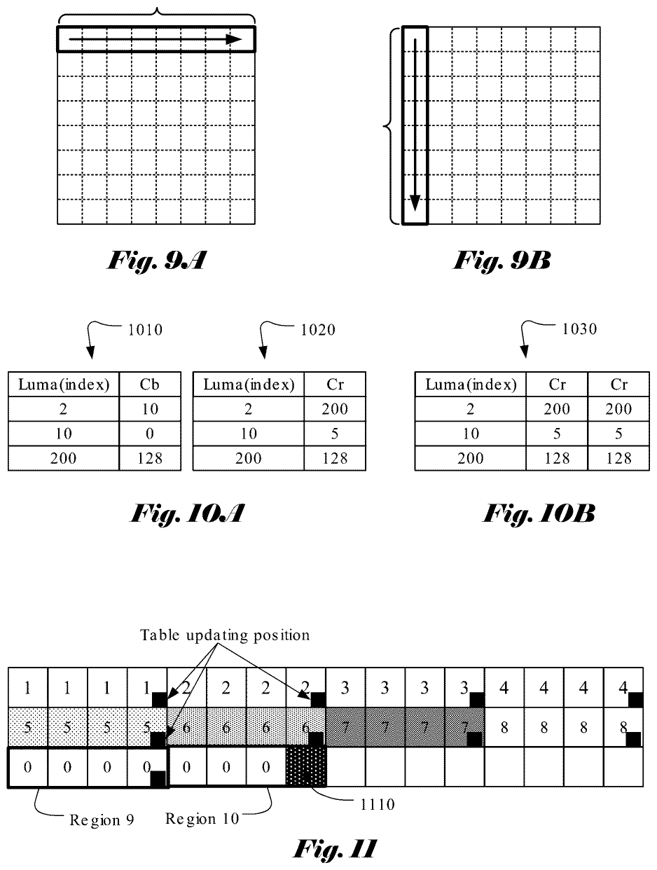

In a similar way as the Coefficient Group (CG) used in transform coefficient coding, a CU coded with palette mode is divided into multiple line-based coefficient group, each consisting of m samples (i.e., m=16), where index runs, palette index values, and quantized colours for the escape mode are encoded/parsed sequentially for each CG. Same as in HEVC, horizontal or vertical traverse scan can be applied to scan the samples, as shown in FIG. 9A and FIG. 9B.

The encoding order for palette run coding in each segment is as follows: For each sample position, one context coded bin run_copy_flag=0 is signalled to indicate if the pixel is of the same mode as the previous sample position, i.e., if the previously scanned sample and the current sample are both of run type COPY_ABOVE or if the previously scanned sample and the current sample are both of run type INDEX and the same index value. Otherwise, run_copy_flag=1 is signalled. If the current sample and the previous sample are of different modes, one context coded bin copy_above_palette_indices_flag is signalled to indicate the run type, i.e., INDEX or COPY_ABOVE, of the current sample. Here, the decoder doesn't have to parse run type if the sample is in the first row (horizontal traverse scan as shown in FIG. 9A) or in the first column (vertical traverse scan as shown in FIG. 9B) since the INDEX mode is used by default. With the same way, the decoder doesn't have to parse run type if the previously parsed run type is COPY_ABOVE. After palette run coding of samples in one coding pass, the index values (for INDEX mode) and quantized escape colours are grouped and coded in another coding pass using CABAC bypass coding. Such separation of context coded bins and bypass coded bins can improve the throughput within each line CG.

For slices with dual luma/chroma tree, the palette is applied on luma (Y component) and chroma (Cb and Cr components) separately, with the luma palette entries containing only Y values and the chroma palette entries containing both Cb and Cr values. For slices of single tree, palette will be applied on Y, Cb and Cr components jointly (i.e., each entry in the palette containing Y, Cb, Cr values). When a CU is coded using a local dual tree, coding of luma and chroma is handled separately. In this case, if the corresponding luma or chroma blocks are coded using the palette mode, the palette is applied in a way similar to the dual tree case.

For slices coded with the dual tree, the maximum palette predictor size is 63, and the maximum palette table size for coding of the current CU is 31. For slices coded with the dual tree, the maximum predictor and palette table sizes are halved, i.e., maximum predictor size is 31 and maximum table size is 15, for each of the luma palette and the chroma palette. For deblocking, the palette coded block on the sides of a block boundary is not deblocked.

In order to improve performance of cross-component prediction, a new cross-component prediction coding tool based on one or more cross-component palette tables are disclosed as follows.

Cross-component model prediction modes, such as CCLM and CCCM, are adopted in the VVC and the ECM to exploit the cross-component redundancy. The chroma samples are predicted based on the reconstructed luma samples of the same blocks based on a linear model or a convolutional model. In this disclosure, methods related to predicting chroma samples based on a discrete model (also named cross-component palette based prediction mode) are proposed to improve the cross-component prediction accuracy or coding performance.

A cross-component discrete model comprises lookup tables, in which the luma value and chroma value mapping relationship is recorded. In some other embodiments, the cross-component discrete model corresponds to such lookup tables, which should not be limited in this disclosure. The luma values (e.g., sample intensity) are the indexes of the lookup tables. To predict the chroma sample value in current block by the cross-component discrete model, the collocated luma sample value is looked up in the lookup tables and the corresponding chroma values in the tables are used to predict the chroma sample value in current block. The cross-component discrete model or the cross-component palette based prediction mode is built based on luma and chroma reconstructed or prediction samples of previous coded blocks.

In one embodiment, the cross-component discrete model comprises one lookup table for each colour component respectively. For example, the cross-component discrete model may have one lookup table to record the luma and Cb-component relationship, and another lookup table to record the luma and Cr-component relationship. FIG. 10A illustrates an example of separate tables for Luma-Cb (Table 1010) and Luma-Cr (Table 1020). In another embodiment, the cross-component discrete model comprises one lookup table for all colour components. For example, the cross-component discrete model may have one table to record the luma value and the corresponding Cb and Cr component values. FIG. 10B illustrates an example of single table for Luma-Cb/Cr (Table 1030).

In one embodiment, the cross-component discrete model is built based on luma and chroma reconstructed or prediction samples. After encoding/decoding a block, the mapping relationship between luma and chroma reconstructed or prediction sample values are used to update the model. If the luma value does not exist in the index, the luma/chroma mapping relationship is added into the model. If the luma value already exists in the indexes, the new chroma value will replace the original chroma value in the model. In another embodiment, if the luma value already exists in the indexes, the chroma value in the model is updated according to both the new chroma value and the original chroma value in the model.

In another embodiment, when updating the model, for the luma and chroma samples used to update the model, if there is one luma value that corresponds to more than one chroma values, the average of the chroma values is used to update the model. In another embodiment, the majority value of the corresponding chroma values is used to update the model. For example, if there are three chroma values, 2, 2, and 10, corresponding to luma value Y, the chroma value 2 is used to update the model. If the majority rule cannot decide the chroma value (e.g., 2, 2, 10, and 10 chroma values), one default can be applied. For example, the latter group value or first group value is used. In another example, the value closest to centre intensity value (e.g., (1<<(bit-depth−1)) or the centre intensity after LMCS) can be used.

In one embodiment, the cross-component discrete model is built only based on luma and chroma reconstructed or prediction samples from blocks coded in certain types. For example, only luma and chroma reconstructed or prediction samples from blocks coded in cross-component modes, such as cross-component discrete model, CCLM, CCCM and their variants, are used to update the model. For another example, only luma and chroma reconstructed or prediction samples from blocks coded with cross-component discrete model are used to update the model. In one example, even when the current block is not coded in the cross-component discrete model, but coded in CCLM, CCCM or their variants, the samples used to derive the CCLM/CCCM/GLM and their variants models, can also be used to update the cross-component discrete model table.

In one embodiment, one cross-CUs cross-component discrete model can be maintained. The cross-component discrete model can be reset at the start of the current picture, current slice, current tile, CTU group, every M CTU rows or every N CTUs, N and M can be any value greater than 0. In another embodiment, the cross-component discrete model can be reset at the end of the current picture, current slice, current tile, CTU group, current CTU row or current CTU.

In another embodiment, multiple cross-component discrete models can be maintained. One picture can be divided into several regions, and for each region, one cross-component model, built based on luma and chroma reconstructed or prediction samples in this region, is kept. The size of the regions is pre-defined, and it can be X×Y CTUs where X and Y can be any value greater than 0. If there are a total of N regions in one picture, a total of N cross-component discrete models are maintained, denoted as cross-component discrete model 1 to cross-component discrete model N. In one embodiment, there can be another cross-component discrete model denoted as cross-component discrete model 0. The cross-component discrete model 0 will always be updated during the encoding/decoding process. The cross-component discrete model 0 will be updated once the block finishes encoding/decoding. When the end of one region is reached, the cross-component discrete model of that region will be updated by the cross-component discrete model 0. FIG. 11 illustrates an example of multi-region based cross-component palette based prediction mode, where the size of region is 4×1 CTUs.

In another embodiment, one picture can be divided into multiple regions, and for each region, a cross-component model is kept. Both the cross-component discrete model 0 and one additional regional cross-component discrete model will be updated during the encoding/decoding process. The additional regional cross-component discrete model can be determined by the current position. For example, if the current CU is located in the second region, the additional regional cross-component model to be updated is cross-component discrete model 2.

In one embodiment, when multiple cross-component discrete models are maintained, the current chroma value can be predicted based on model 0 or other regional models. The model chosen can be signalled. In another embodiment, when multiple cross-component discrete models are maintained, the current chroma value can be predicted based on model 0 or neighbouring regional models of pre-defined regions. The model chosen can be signalled. For example, as in FIG. 11, the nearest region on top of the current block is region 6, then the current chroma value can be predicted based on model 0 or model 6.

In another embodiment, when multiple cross-component discrete models are maintained, the neighbouring regional models can be merged with model 0 to form a merge model, and the current chroma value is predicted based on the merged model. The regional models to be merged can be determined by the current block position. For example, the model of the nearest region on the top of current block is merged with model 0. As shown in FIG. 11, the regional model 6 is to be merged with model 0. For another example, the model of the region on the top of the current block and the model of the region at top-left of the current block are merged with model 0. As shown in FIG. 11, the regional model 6, the regional model 5 and model 0 are merged. When merging multiple models, one or more merge rules can be applied. For example, the current model has higher priority than other models. When the current model has a hole (i.e., a luma index does not exist in the model), the empty entry can be filled by other entries of other models.

In another embodiment, when multiple cross-component discrete models are maintained, the neighbouring regional models can be merged into one model, and the current chroma value is to be predicted based on the merged model. The regional models to be merged can be determined by the current block position. For example, the model of the region on the top of the current block, the model of the region left to the current block and the model of the current region are merged. As in FIG. 11, the regional model 6, the regional model 9 and the regional model 10 are merged.

In one embodiment, when merging multiple models, if the same luma value exists in more than one model, the merged model may take the chroma value of the model with the highest priority. The priority of the model can be pre-defined. For example, model 0 may have the highest priority. The priority of the models can be pre-defined according to the relative position of the region associated with the model to the current position. For example, the priority of the regions can be in the order of current region, top region, left region, top-left region. As in FIG. 11, the priority of the regions is in the order of Region 10, Region 6, Region 9, and then Region 5.

In another embodiment, when merging multiple models, if the same luma value exists in more than one model, the merged model takes the average of the corresponding chroma values. In another embodiment, when merging multiple models, if the same luma value exists in more than one model, the merged model takes the majority value of the corresponding chroma values. For example, if three models are merged, and the corresponding chroma values of the luma value Y are 2, 2, and 10 in each model respectively, then the merged model takes 2 as the chroma value.

In one embodiment, when predicting current chroma value based on a cross-component discrete model, if the collocated luma sample value does not exist in the model, the average value of the neighbouring luma samples can be used to predict the current chroma value. For example, the average value can be the average of the neighbouring luma samples of the current block. For another example, the average value can be the average of the collocated luma samples of the current block. In another embodiment, if the collocated luma sample value does not exist in the model, values closest to the collocated luma value are searched. For example, if the collocated luma value is Y, and Y does not exist in the model, the luma values Y−1, Y+1, Y−2, Y+2, to Y−N and Y+M are searched in order, where N and M are integer numbers.

In another embodiment, a cross-component model (e.g., CCLM/CCCM model) can be derived based on the neighbouring chroma and luma samples of the current block. When predicting current chroma value based on a cross-component discrete model, if the collocated luma sample value does not exist in the model, the current chroma value is predicted by the CCLM/CCCM model derived. In another embodiment, for each cross-component discrete model, a CCLM/CCCM model can be derived based on chroma and luma values in the model. When predicting the current chroma value based on the model, if the collocated luma sample value does not exist in the model, the current chroma value is predicted by the CCLM/CCCM model derived. In another example, when there are multiple samples with the same luma value but with different chroma values, the chroma value closest to the value derived by cross-component model is used. In another example, when there are multiple samples with the same luma value but with different chroma values, the chroma value derived by cross-component model is used.

In another embodiment, when predicting current chroma value based on a cross-component discrete model, if the collocated luma sample value does not exist in the model, the current chroma value can be predicted based on the interpolation or extrapolation of luma/chroma values existing in the model. For example, let the collocated luma sample value be Y and Y does not exist in the model. The two luma values closest to Y in the model are Y1 and Y2, that is, abs(Y1−Y) and abs(Y2−Y) are the two smallest differences among all the luma values in the model. C1 and C2 are the corresponding chroma value of Y1 and Y2 in the model respectively. If Y1<Y<Y2 or Y2<Y<Y1, the current chroma value C can be predicted by linearly interpolating (Y1, C1) and (Y2, C2). If Y<Y1 and Y<Y2, or Y>Y1 and Y>Y2, then the current chroma value C can be predicted by linearly extrapolating (Y1, C1) and (Y2, C2). For another example, if Y is greater than all the luma values in the model, and the closest luma value in the model is Y1, that is, abs(Y1−Y) is the smallest difference among all the luma values in the model, and C1 is the corresponding chroma value of Y1 in the model. Assuming the maximum allowed luma value is YL and the maximum allowed chroma value is CL (e.g., YL=CL=1024, if the bit depth=10), the current chroma value C value can be predicted by linearly interpolating (Y1, C1) and (YL, CL). For another example, if Y is smaller than all the luma values in the model, and the closest luma value in the model is Y1, that is, abs(Y1-Y) is the smallest difference among all the luma values in the model, and C1 is the corresponding chroma value of Y1 in the model. The current chroma value C value can be predicted by linearly interpolating (Y1, C1) and (0, 0). For another example, if Y is greater or smaller than all the luma values in the model, and the closest luma value in the model is Y1, that is, abs(Y1−Y) is the smallest difference among all the luma values in the model, and C1 is the corresponding chroma value of Y1 in the model, then the current chroma value is predicted as C1.

In another embodiment, the cross-component discrete model can be adaptively applied (determined implicitly or by signalling) or can be always applied when the current block is coded in certain modes, e.g., cross-component modes such as CCLM, CCCM, GLM, and/or their variants models. The samples used to construct the cross-component models are analysed. For one luma value, intensity or index, if it only occurs once, the corresponding chroma value is used instead of the value derived by the cross-component model. If the luma value, intensity or index occur multiple times, the value derived by the cross-component mode is used. In another example, if the stored value in the discrete model under some conditions (e.g., only occurring once) is closest to the value derived by the cross-component mode (e.g., the difference smaller than some predefined or adaptive threshold), the stored value in the discrete model is used. In another example, if the stored value in discrete model under some conditions (e.g., only occurs once) is far from to the value derived by the cross-component mode (e.g., the difference is larger than some predefined or adaptive threshold), the stored value in the discrete model is used. In another example, when there are multiple samples with the same luma value but with different chroma values, the stored discrete chroma value closest to the value derived by cross-component model is used. In another embodiment, one or more rules are used to determine whether to use the stored discrete chroma value or use the value derived by the cross-component mode.

In another embodiment, the table of cross-component discrete model can be shared with the palette mode. The colour stored in palette table can be used to update the table of the cross-component discrete model. When a current block was coded in palette mode, the colour values stored in palette table can be used to update the table of the cross-component discrete model. The similar mechanism can be applied to the palette mode as well. For example, the table of cross-component discrete model or the values in the table of cross-component discrete model can be used to update the colour in palette table. In another embodiment, when coding the escape samples, the table of cross-component discrete model can be used. For example, it may only need to transmit one or more colour component values of the escape samples, the values of the not signalled colour components can be derived by using the table of cross-component discrete model. In another embodiment, the palette colour table signalling can utilize the table of cross-component discrete model. For example, some entries in the table of cross-component discrete model can be used as one of the palette colours.

In another embodiment, when predicting the current chroma sample value based on a cross-component discrete model, for each sample in the current block, it can copy the prediction sample value from one of above-side neighbouring samples, one of left-side neighbouring samples, look up from the lookup tables, or derived from cross-component prediction models. If a sequence of samples in the current block has the same copy/look up/derivation behaviour, it can signal a run value to indicate the sequence length. For example, under the current sample reconstruction order, a sequence of samples all look up the prediction values from the lookup tables, a run value is indicated to present the length of the sequence of samples. For another example, under the current sample reconstruction order, a sequence of samples all derive prediction values from cross-component prediction models, a run value is indicated to present the length of the sequence of samples.

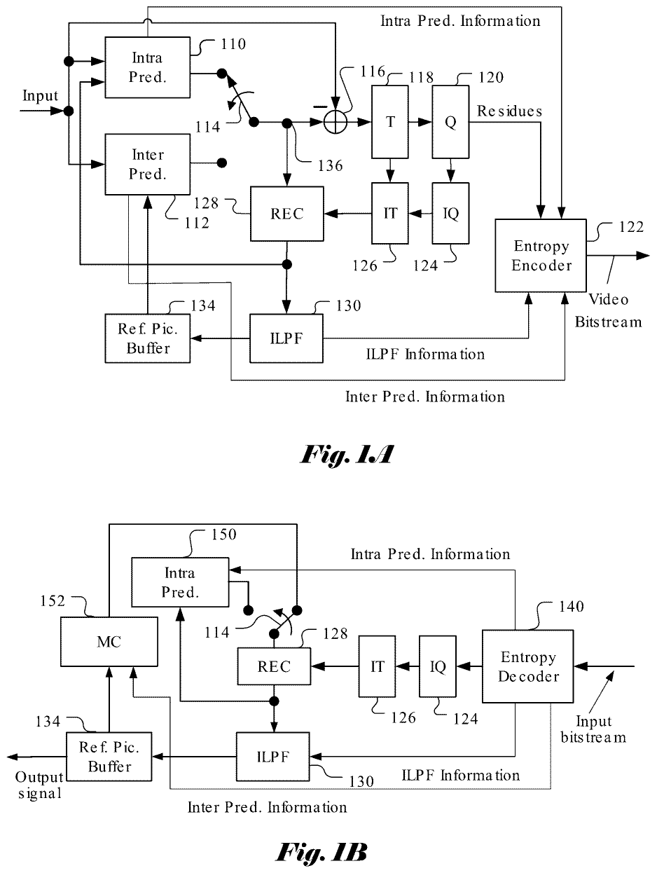

Any of the foregoing proposed cross-component palette based prediction methods can be implemented in encoders and/or decoders. For example, any of the proposed methods can be implemented in an inter/intra/prediction module of an encoder, and/or an inter/intra/prediction module of a decoder. Alternatively, any of the proposed methods can be implemented as a circuit coupled to the inter/intra/prediction module of the encoder and/or the inter/intra/prediction module of the decoder, so as to provide the information needed by the inter/intra/prediction module. In one example, any of the proposed cross-component palette based prediction methods can be implemented in an Intra/Inter coding module (e.g. Intra Pred. 150/MC 152 in FIG. 1B) in a decoder or an Intra/Inter coding module is an encoder (e.g. Intra Pred. 110/Inter Pred. 112 in FIG. 1A). Any of the proposed methods can also be implemented as a circuit coupled to the intra/inter coding module at the decoder or the encoder. However, the decoder or encoder may also use additional processing unit to implement the required cross-component prediction processing. While the Intra Pred. units (e.g. unit 110/112 in FIG. 1A and unit 150/152 in FIG. 1B) are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

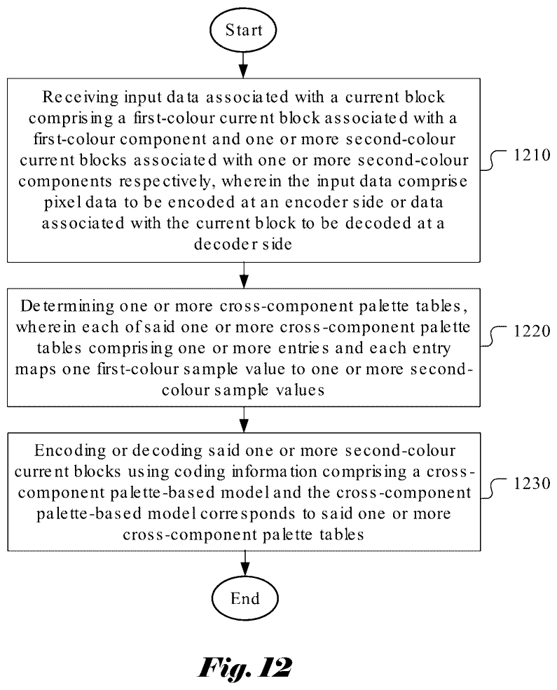

FIG. 12 illustrates a flowchart of an exemplary video coding system that incorporates cross-component palette-based models according to an embodiment of the present invention. The steps shown in the flowchart may be implemented as program codes executable on one or more processors (e.g., one or more CPUs) at the encoder side. The steps shown in the flowchart may also be implemented based hardware such as one or more electronic devices or processors arranged to perform the steps in the flowchart. According to this method, input data associated with a current block comprising a first-colour current block associated with a first-colour component and one or more second-colour current blocks associated with one or more second-colour components respectively are received in step 1210, wherein the input data comprise pixel data to be encoded at an encoder side or data associated with the current block to be decoded at a decoder side. One or more cross-component palette tables are determined in step 1220, wherein each of said one or more cross-component palette tables comprising one or more entries and each entry maps one first-colour sample value to one or more second-colour sample values. Said one or more second-colour current blocks are encoded or decoded using coding information comprising a cross-component palette-based model and the cross-component palette-based model corresponds to said one or more cross-component palette tables in step 1230.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of coding colour pictures using coding tools including one or more cross component models related modes, the method comprising:
receiving input data associated with a current block comprising a first-colour current block associated with a first-colour component and one or more second-colour current blocks associated with one or more second-colour components respectively, wherein the input data comprise pixel data to be encoded at an encoder side or data associated with the current block to be decoded at a decoder side;
determining one or more cross-component palette tables, wherein each of said one or more cross-component palette tables comprising one or more entries and each entry maps one first-colour sample value to one or more second-colour sample values; and
encoding or decoding said one or more second-colour current blocks using coding information comprising a cross-component palette-based model and the cross-component palette-based model corresponds to said one or more cross-component palette tables.

2. The method of claim 1, wherein the first-colour current block corresponds to a luma block and said one or more second-colour current blocks corresponds to a first chroma block and a second chroma block.

3. The method of claim 2, wherein said one or more cross-component palette tables correspond to a first cross-component palette table and a second cross-component palette table, and wherein each entry of the first cross-component palette table maps one luma sample value to one first chroma sample value and each entry of the second cross-component palette table maps one luma sample value to one second chroma sample value.

4. The method of claim 2, wherein said one or more cross-component palette tables correspond to a joint cross-component palette table, and wherein each entry of the joint cross-component palette table maps one luma sample value to one first chroma sample value and one second chroma sample value.

5. The method of claim 1, wherein a second-colour sample in the current block is predicted by using said one or more cross-component palette tables, and wherein a first-colour sample value for a collocated first-colour sample corresponding to the second-colour sample is looked up in said one or more cross-component palette tables to determine a corresponding second-colour value as a predicted second-colour value for the second-colour sample.

6. The method of claim 1, wherein said one or more cross-component palette tables are built based on reconstructed or prediction samples, at collocated location, of the first-colour component and said one or more second-colour components in one or more previously coded blocks.

7. The method of claim 1, wherein one cross-component palette-based model is maintained across multiple CUs (Coding Units) and said one cross-component palette-based model is reset at beginning or end of a current picture, slice, tile, CTU (Coding Tree Unit) group, M CTU rows or N CTUs.

8. The method of claim 1, wherein each picture is divided into N regions and N cross-component palette-based models are maintained, and wherein each cross-component palette-based model is derived based on reconstructed or prediction samples of the first-colour component and said one or more second-colour components in each region and N is a positive integer greater than 1.

9. (canceled)

10. The method of claim 8, wherein two or more of the N cross-component palette-based models are merged to form a merged cross-component palette-based model, and the merged cross-component palette-based model is used for encoding or decoding said one or more second-colour current blocks.

11. (canceled)

12. (canceled)

13. (canceled)

14. (canceled)

15. (canceled)

16. (canceled)

17. (canceled)

18. (canceled)

19. The method of claim 1, wherein if a cross-component prediction mode is enabled for the current block, said one or more second-colour current blocks are adaptively encoded or decoded using the cross-component prediction mode or said one or more cross-component palette tables.

20. (canceled)

21. (canceled)

22. (canceled)

23. (canceled)

24. The method of claim 1, wherein said one or more cross-component palette tables are shared with a palette table used for a palette prediction mode.

25. The method of claim 24, wherein said one or more cross-component palette tables are used to update the palette table, or the palette table is used to update said one or more cross-component palette tables.

26. The method of claim 24, wherein when a target sample in the current block is encoded or decoded by an escape code in the palette prediction mode, or when signalling a new palette entry, said one or more cross-component palette tables are used for signalling or parsing a target sample value for the target sample.

27. The method of claim 26, wherein the first-colour component corresponds to luma component and said one or more second-colour components correspond to two chroma components, and only the luma component of the target sample is signalled.

28. The method of claim 27, wherein the two chroma components of the target sample are derived according to said one or more cross-component palette tables.

29. An apparatus for video coding, the apparatus comprising one or more electronics or processors arranged to:
receive input data associated with a current block comprising a first-colour current block associated with a first-colour component and one or more second-colour current blocks associated with one or more second-colour components respectively, wherein the input data comprise pixel data to be encoded at an encoder side or data associated with the current block to be decoded at a decoder side;
determine one or more cross-component palette tables, wherein each of said one or more cross-component palette tables comprising one or more entries and each entry maps one first-colour sample value to one or more second-colour sample values; and
encode or decode said one or more second-colour current blocks using coding information comprising a cross-component palette-based model and the cross-component palette-based model corresponds to said one or more cross-component palette tables.
